(19) United States
(12) Patent Application Publication
(10) Pub. No.: US 2001/0049625 A1
(43) Pub. Date: Dec. 6, 2001

(54) Method and system for eliciting consumer data by programming content within various media venues to function cooperatively

(76) Inventor: Craig Mowry, Southampton, NY (US)

Correspondence Address: OSTROLENK FABER GERB & SOFFEN, 1180 AVENUE OF THE AMERICAS, NEW YORK, NY, 100368403

(21) Appl. No.: 09/756,581

(22) Filed: Jan. 8, 2001

Related U.S. Application Data
(60) Provisional application No. 60/175,093, filed on Jan. 7, 2000.
(60) Provisional application No. 60/176,440, filed on Jan. 14, 2000.
(60) Provisional application No. 60/189,060, filed on Mar. 14, 2000.
(60) Provisional application No. 60/212,663, filed on Jun. 20, 2000.
(60) Provisional application No. 60/226,672, filed on Aug. 22, 2000.

(51) Int. Cl. G06F 17/60

(52) U.S. Cl. 705/14

(57) ABSTRACT

A multimedia system and method which includes a television program, an electronic commerce catalog, an interactive Internet site and an electronic communications network linking the television program, the electronic commerce catalog and the interactive Internet site. The system and method is designed such that the users of the Internet site affect the content within the live television program, and the live television program is produced to function in tandem with the Internet site such that the content of the program determines the content of the electronic commerce catalog.

### BACKGROUND OF THE INVENTION

1. Field of the Invention

The present invention relates to an interactive communication network-based marketing system and method, and more specifically, to a system and method in which a web site and live program are arranged in the form of a game which captures marketing data from system users and promotes those products and services which are favorably viewed by a corresponding demographic community.

2. Description of the Related Art

Many Internet sites, i.e., web sites, provide limited services and limited entertainment options due typically to site configurations based on singular or limited objectives. The value of an audience from a target demographic participating in a single site cannot be underestimated nor should it be narrowed to such limited objectives, services and benefit to site users.

The number of site participants, the time the participants spend at a single site and the degree of interactivity with the site have typically been the key variables exploited from the perspective of the site participant (user). Increasing potential revenue, services and entertainment value to the user beyond those variables must therefore lie in creating a multi-leveled, or multi-dimensional site. In cooping various media to create a new multi-media venue, a target demographic can potentially be sampled with startling speed and with unfaltering accuracy. Existing sites and attempts at “convergence” between television and the Internet have failed to exploit the cooping potential of these media. Also, the demographic sampling potential for a variety of information needs, including product and service preferences, has been all but untapped to date.

The present invention involves a new multimedia venue to sample, sell, educate and entertain both site users and television viewers having a common demographic.

### SUMMARY OF THE INVENTION

Audience “viewership” split between media venues is brought together within a new, potent “multi-media coop” providing an enhanced interactive audience by way of a new combination of the benefits and dynamics of existing media venues, usually kept separate and distinct.

By involving an Internet site in the programming of a live television program, for instance, the opportunity for the demographic being sampled to function as the writers, or “programmers,” creates a new type of entertainment program. In making products and services an element of the content that the demographic is programming, through their feedback over the Internet, members of a shared demographic express preferences and give immediate feedback while simultaneously being entertained.

An object of the present invention is to provide new Internet services and new options for data sampling and interactive involvement among Internet users; preferably having a common demographic. Further, the present invention provides for the creation of an electronic catalog of purchasable or auctionable items merchandised completely based on the preferences of the target demographic, as expressed through feedback on a linked Internet site. This user determination of programming content and the merchandise options provide a higher potential interest level to all members of the selected focus demographic.

A further objective is the collection of revenue from a multitude of potential sources, including membership fees, vendor partnerships, advertising, the sale of the immediate market data derived from site user responses, sale of merchandise and services, among other possibilities.

A further objective is to provide educational services and opportunities to a selected demographic, such as teenagers. These services and opportunities include: the ability for users to collaborate educational rewards that may be acquired by meeting certain site parameters; rewards for selected demonstrations of support and help between site users and social services; and emergency help options for users who may not have acceptable access to such help services.

The present invention advantageously allows audience “viewership”, typically split between media venues, to come together within a new, potent “multi-media coop”, providing an enhanced interactive audience by way of a new combination of the benefits and dynamics of existing media venues, previously kept separate and distinct.

By involving an Internet site in the programming of a live television program, the opportunity for the demographic being sampled to function as the writers, or “programmers”, creates a new type of entertainment program. In making products and services an element of the content that the demographic is programming, through their feedback over the Internet, members of a shared demographic can express preferences and give immediate feedback while simultaneously being entertained.

By marrying the data sampling advantages and immediacy of an Internet site with a live “television style” program, a unique venue of entertainment and “e-commerce” is created resulting in a television show and selection of marketed merchandise created entirely by feedback from the target demographic.

Participants in a theme-based Internet site directly influence, control and provide content elements of a television-style program through data they provide through the Internet. These data may include their purchasing preferences and personal opinions, private thoughts and actual video and audio transmitted by participants to the site. Further, their data is considered for potential inclusion in the linked television program.

By providing the incentives of a live game show, the human interest of a global talk show, and the commercial benefits of a “shop-at-home channel”, a site geared towards a specific demographic, such as teenagers, can: 1) entertain, 2) sample data in real time, and 3) determine preferences and sell or auction these preferred products and services directly to site members.

From the home Internet participants, to the producers who steer the television production, the target demographic group decides on content, including the products and services to be sampled and evaluated and the guests to be featured.

For the time period in which the television program is not occurring live, and the site is operational, the invention provides for the creation of a unique “e-commerce” catalog. This catalog provides for ongoing content-determining interaction from the Internet audience, as well as continued selling potential. By indexing the catalog according to a variety of options, including the images and traits of guests featured within the linked television program, the invention provides for a new venue of e-commerce, cataloged according to individuals that shoppers may want to identify with, or know more about, for personal identification and taste comparison.

Further, a site constructed in accordance with the present invention preferably allows multi-level incentives, presented in an entertaining “game” form, based on collaboration between site members toward a common goal or achievement, can stimulate interactivity with the target demographic group. This allows for a unique combination of selling, entertaining, teaching and providing social and educational services, and sampling preferences quickly and accurately from a single demographic group.

Revenue can be derived from options including memberships, exclusive vendor partnerships and cross promotions, the sale of market data, advertising and the sale or auctioning of products and services (either directly from the site or by way of links to e-commerce partner sites.)

Seeing the invention as a combination of components, the “site” stage, the “program” stage, and the “catalog,” the present invention contemplates the creation and maintenance of these distinct components. The interactive Internet site and the fully produced television-style program together then work to merchandise the catalog, ensuring that it is a purchasing venue of the highest possible interest to the target demographic. By combining of these components, the amplification of each component resulting from the typically separate components being interdependent and mutually promotional, is very large.

Further, questions can be posed within the context of a game show-entertainment venue allowing for the sampled demographic to provide “write in” and general preference response data immediately, which otherwise typically can only be accumulated by way of costly and cumbersome focus group studies. Focus groups studies embody the type of data which helps to track trends and changes in preferences.

Seeing the television program as a daily single hour live real time video feature on the site, for instance, site members' (participants') involvement is likely to be most intensely be focused to the time of the “program.” Opportunities for simulcast of the “program” on television cable television or other media vehicles is another special value of the “program” aspect present invention. Reciprocally, results and material from each installment of the “program” provides product options and uniquely reference material for the site during the other hours of the day, as the “catalog.” Also, during the hours in which the site operates separate from the live program, members can participate in a collaborative programming process which is important in determining who from the Internet audience will become featured guests of the program.

As such, the Internet audience functions as writer and programmer of the program. Those interacting with the site might be viewing the simulcast of the program on a television monitor, perhaps until technology allows for acceptable real time video viewing on computers more broadly.

In terms of electronic commerce, products and information determined by responses and feedback of site members, typically from a similar demographic group, provides a new level of interest in the items and services featured and current and future trends. Further, in displaying “preview” information and options for the upcoming episodes of the “program,” participants in the site can find opportunity to accrue redeemable credit on the site in working the site options or playing the site game prior to each next “program” installment, which may serve as the climax to each day's game(s.) The potent combination of elements in this invention provide for the creation of a “cyber catalog” built directly from the appearances and preferences of site members, as featured in past live “program” segments, indexed by a myriad of options including the personalities, preferences and even the appearances of those site member “program guests.”

Pages of this catalog can be indexed by both product category and actual people who have been featured in the “program.” These indexed pages can include images of the site participants and video clips of these participants from their past appearance on the related “program,” to allow those reviewing the catalog to reference information based on their interest in the people on which the pages are organized, allowing for new options of relating to preferences, traits and opinions of selected people of interest to catalog “readers.” Transactions for merchandise can occur directly on the site, as sales and auctions, or by way of links to partner e-commerce sites.

With respect to the program, the interactive site provides: 1) the guests for the “program” (appearing visually by way of remote video feeds); 2) individual and collective feedback from site members to questions, and prompts providing added interest in others' opinions; 3) demographic information about products and options of interest for future shows; and 4) a guaranteed minimum viewership of the “program” from site participants who view the program via the Internet on their user terminal displays or via simulcast on another monitor. Further, the opportunities for further viewership from a simulcast to non-members of the site are possible, as is the potential for many of those non-Internet viewers to be drawn to participate or join the related site.

The application of the present invention for many groups who share interests of demographics is quite large. The possibility of many sites with related programs, designed to appeal to distinct groups sharing specific traits or interests, and even specially cataloged information from these programs, can exist. In each instance and for each demographic group, the key to this multimedia venue's potency lies in the level of control and content determination the Internet audience is allowed. Not unlike the editorial content of a magazine, if everything including products and services included within the program are determined or “accepted” by the interactive “producers” at home, the interest level and data sampling integrity of the venue to the selected consumers is enhanced.

Accordingly, the present invention provides a method for facilitating the exchange of data between sources in which the sources include:

a selected interactive Internet site;

a selected a live episodic television program;

selected product and service providers; and

a selected electronic commerce catalog.

The present invention also provides a marketing method for constructing a multimedia venue which elicits live response data from consumers. The marketing method provides an interactive Internet site which allows consumers to selectively affect content within a separate live television program. The live television program is produced to function in tandem with the site such that the content of the program further determines the selected content of a separate electronic commerce catalog.

Another aspect of the present invention provides a method for facilitating the exchange of data between selected sources, in which an interactive Internet site is programmed, the site including means to mutually exchange selected text, video and audio data with remote participants. A live episodic telecast is distributed, the telecast being selectively programmed to function in tandem with the site. Selected providers of products and services are coordinated, products and services from the selected providers being selectively featured within the content of the site and the production, the products and services being featured include incorporation as content bases for selected reactions from remote participants, the selected reactions including selected data solicited by the providers from the participants.

As still another aspect of the present invention, the telecast features selected data relayed from the site for inclusion therein, and provides the telecast to the site as video and audio data for selective inclusion within the content of the site. Further, the telecast is selectively distributed in at least one telecasting format, the telecasting format including streaming video transmission.

As still yet another aspect of the present invention, the streaming video transmission occurs via the Internet.

As still another aspect, the method further includes compiling an interactive Internet archive, the archive being included within the site, the archive including selected data provided from the site and the telecast.

As still yet another aspect of the present invention, the archive is catalogued and includes an index by which the participants access data within the archive using at least one option, the at least one option includes predetermined content categories pertaining to aspects of selected episodes of the telecast including selected aspects of the participants.

Another aspect of the present invention further allows participants to request the selected goods and services featured within the archive. Preferably, requested items are sold to a requesting participant in accordance with a credit-based transaction.

The present invention also provides a method for sampling demographic-specific consumer data using media venues programmed to operate cooperatively, the venues including at least one of, a selected interactive Internet site, a selected live episodic television program and a selected electronic commerce catalog, in which data are elicited from selected consumers. Consumer data are gathered. The media venues are linked thereby increasing the value of consumer demographic data to selected suppliers of goods and services to whom the sampled data is provided.

The present invention also provides a system which facilitates an exchange of demographic-specific consumer, in which the system includes a venue. At least one source is coupled to the venue, the sources including suppliers of goods and services, an electronic commerce catalog, at least one user terminal, and a live episodic television program.

An additional aspect of the present invention provides that the catalog is indexed according to variables, the variables including selected traits of selected participants of the interactive site who have been featured within the content of the program.

As still yet another aspect of the present invention, a multimedia venue is provided for facilitating the exchange of data between vendors and consumers, in which the multimedia venue includes an interactive electronic commerce Internet site and a live television program, the site and the program being interdependent for selected aspects of their respective content.

As still another aspect of the present invention, the site includes an electronic commerce catalog, the catalog being indexed in accordance with the content of the program.

As still yet another aspect of the invention, the electronic commerce catalog is indexed in accordance with traits of interactive participants of the site who have been featured within the content of the program.

As another aspect of the present invention, participants are featured visibly and audibly within the content of the program, the visible and audible feature being accomplished by way of live video and audio content transmitted to the site by terminals used by the featured participants.

The present invention also provides a system which uses a communication network to exchange data between vendors and consumers, in which there is an electronic commerce Internet catalog coupled to the communication network. An interactive electronic commerce Internet site is coupled to the communication network. A live program processor is coupled to the communication network to facilitate the production of a live episodic television program in accordance with content derived from the catalog and which is dependent on data from the site.

As still yet another aspect of the present invention, a multimedia venue for eliciting demographic specific consumer data from player terminals is provided in which the venue has an interactive Internet site and selected a live episodic television program, the site comprising a catalog database. The site and the program function in tandem to stimulate participants to use corresponding player terminals to transmit consumer data to the site. The transmitted consumer data is stored within the catalog database. The catalog database is arranged according to selected content aspects of the live episodic program.

As another aspect of the present invention, the program is selectively electronically transmitted to viewers using at least one of conventional telecasting techniques and real-time video data transmission across the communication network.

As another aspect of the present invention, a multimedia venue for eliciting data from selected consumers specific to selected demographics is provided in which there are a plurality of interactive Internet exchanges. The elicited data being used to affect the plurality of exchanges to supply data content to a separate live television program in accordance with the elicited data, the program being arranged to have a reciprocal effect on data supplied to the consumers.

As still another aspect of the present invention, the venue further comprises an electronic catalog. The content of the site and the program further determine the content of the electronic catalog.

As another aspect, the site comprises video and audio data received from the program.

The present invention also provides an Internet site for eliciting response data and real time video transmissions from selected interacting participants of said site, in which the site includes a database having a catalog arranged according to content of past episodes of the a concurrent video program and a central processing unit which determines content for a concurrent video program and content for the database.

As still yet another aspect of the present invention, a site having a data archive is provided in which elements of a produced television program are cataloged and stored in the data archive. The elements of the program are determined in accordance with interactive data provided by player terminals in communication with the site. The data archive is indexed in accordance with aspects of program, aspects including selected traits of guests of the program which include selected participants of the site.

As another aspect of the present invention, the selected traits include personality traits, opinions and physical appearances.

As still another aspect of the present invention, goods and services offered by suppliers are evaluated in accordance with the context of the site and the production, content for the site and the production being respectively determined by selected interactive participants of the site, the selected participants being members of the selected consumer demographic being sampled for the selected suppliers of goods and services.

As still another aspect of the present invention, selected participants in said interactive Internet site are featured as text respondents within the program.

As still yet another aspect of the present invention, transmitting data allows the selected participants to accrue credits, the credits having a selectively redeemable value within the site.

As another aspect of the present invention, the data provided by selected members of selected groups of the participants results in a collective effect on credit accruals of the members within the selected groups.

According to another aspect of the invention, the data provided by the selected groups results in a member of a group being rendered more likely to become a participant featured within the program.

According to yet another aspect of the invention, the selected participants interact directly with each other through at least one of messaging and chat software.

As another aspect of the present invention, the selected participants featured within the program are provided with questions. The received answers to the questions serve as the basis of selected prompts for data responses from other site participants.

According to still another aspect of the invention, the site is an electronic commerce site where selected items and services featured are offered for purchase to selected site participants at a determined or auctioned price.

According to another aspect of the invention, the site is constructed in accordance with a multi-level incentive model wherein participant advancement within a site hierarchy is possible.

According to another aspect of the invention, the model for the venue is selected from the group consisting of a societal system, a selected institution and a prison system.

According to still yet another aspect of the invention, the opportunities for interactivity include selectively referencing past data results received from site participants.

According to another aspect of the invention, the opportunities for interactivity include site supplied data prompts and participant responses based on anticipated content and options within future episodes of the program.

According to another aspect of the invention, selected participants meeting selected criteria are provided with the opportunity to receive bonuses in the form of selected free merchandise or services.

According to another aspect of the invention, selected data received from participants selectively affect bonuses and credit provided to featured participants and provided to members of groups in which said featured participants are members.

As still yet another aspect of the present invention, selected participants meeting selected criteria accrue credit by serving as guides for other members of the site who require assistance or instruction.

As another aspect of the present invention, social and educational services are made available to the participants, preferably by providing links to informational and instructional databases.

Other features and advantages of the present invention will become apparent from the following description of the invention which refers to the accompanying drawings.

### BRIEF DESCRIPTION OF THE DRAWINGS

For the purpose of illustrating the invention, there are shown in the drawings several forms which are presently preferred, it being understood, however, that the invention is not limited to the precise arrangements and instrumentalities shown, wherein:

FIG. 1 is a block diagram of an example web site showing access and response data flows in accordance with the present invention;

FIG. 2 is a diagram showing examples of data flows according to the present invention;

FIG. 3 is a diagram of live and recorded video data flows;

FIG. 4 is a diagram showing an example of a hardware arrangement of an interactive network-based marketing system of the present invention; and

FIG. 5 is a block diagram of the functional elements of the SITE processor of the present invention.

### DETAILED DESCRIPTION OF EMBODIMENTS OF THE INVENTION

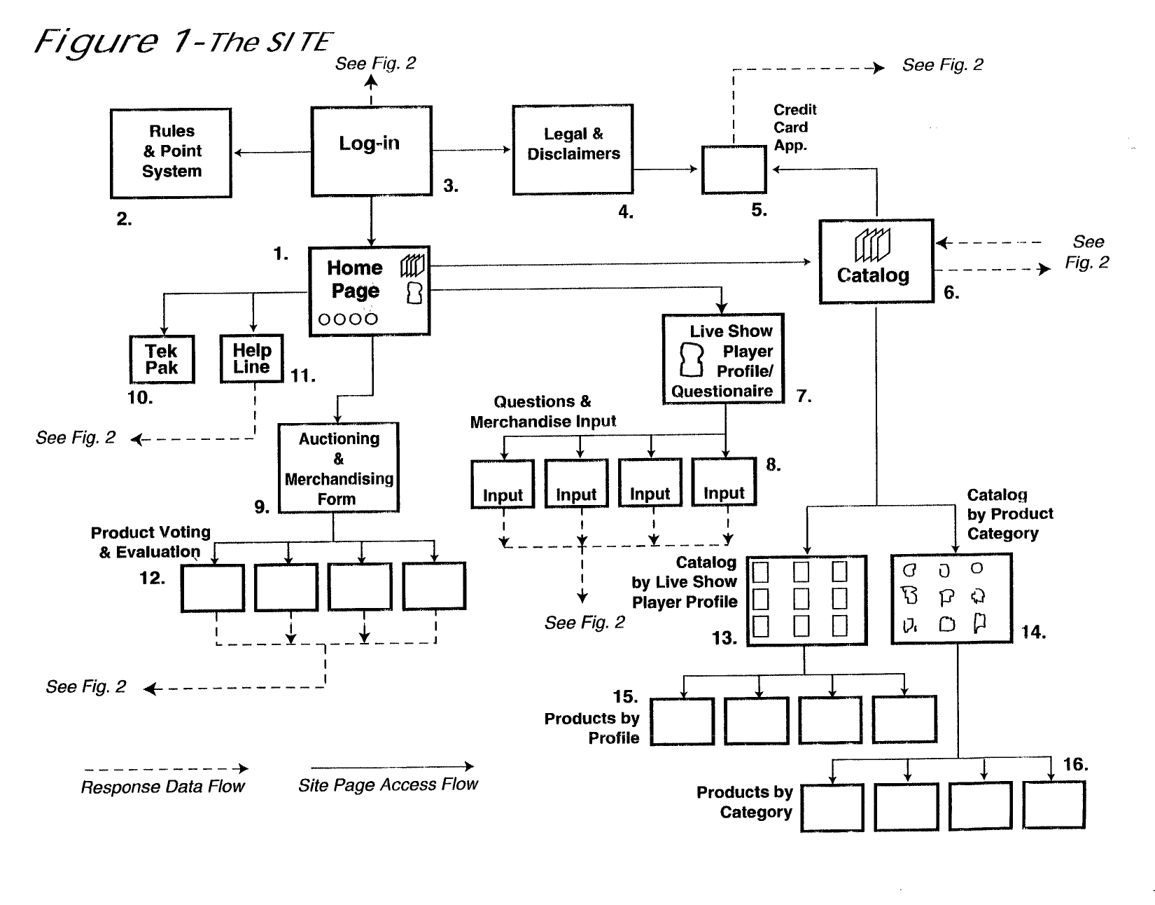

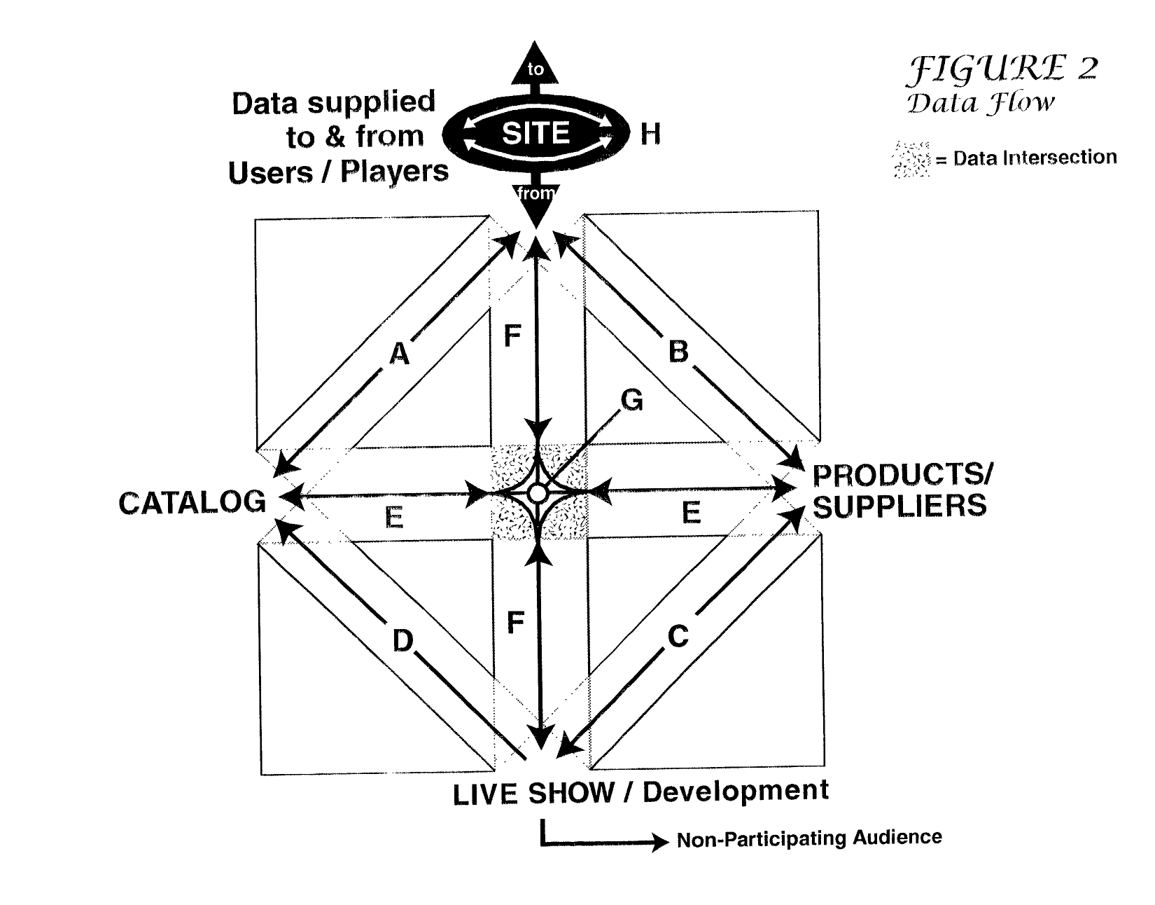

Referring to FIG. 1, an example of a SITE constructed in accordance with the principles of the present invention is shown along with its page access flow, and response data flow. The SITE is represented in the overall data flow as H in FIG. 2. Its details within this Figure are as follows:

HOME PAGE—This is an interactive page within the SITE, accessible only through the log-in at the start of the Uniform Resource Locator (URL) entry. This page allows access to the CATALOG, the Help Line, the TekPak, the auctioning and product evaluation page, the LIVE SHOW subject candidate profile and questionnaire. Links to available prizes and a player's total point tally are preferably accessed via the home page, as are communication links with a player's fellow teammates and the rules to “the game”.

RULES AND POINTS SYSTEM PAGE—This page is accessible to new and existing players as the key source for how to play. The RULES page is accessible from a variety of areas and spells out the do's and don'ts of system usage as well as preferably encompassing a video warning on the obvious issues around “Chat” and maintaining anonymity. There is a stipulation on the points structure as well as how players are combined into groups, for example, 12 player blocks, and that working together as a team will benefit the block as a whole. The role of the “host” is defined, as well as any other hierarchy positions within “the game”. The general rules of play and operation are presented at this page.

LOG-IN—is the first page a new or returning player encounters when they attempt to access the SITE. The player enters either an existing player name and password or requests processing through the player registration form as a new player. Access to SITE pages is limited outside of the log in. Players/visitors can go to the Help page/site (but not the full Help Page within the site for security reasons). New and returning players can go to the rules page, which is at the topmost level of the site, so they can learn how to play. Preferably, there is also a “forget your password?” link. This page is where a player logs their first real data to create a profile that is entered into a database which is engineered to capture information corresponding to the demographic to which “the game” is being applied. This page is identified by the letter H, shown in on FIG. 2.

LEGAL & DISCLAIMERS—This page is the default link page to any new player applicant. A player cannot access the Home Page without reviewing this document. It contains legal information indemnifying the Producers of “the game”. Within this page, there are consent and release forms, agreements, a parental credit block, and product manufacturer credits. There is preferably a Rules page link for easy navigation/reference. Preferably there is also a Chat Room stipulator (this may appear in the Rules page, as well as the Chat link within the Home Page). Pages describing various agreements, releases, applications for credit, parental “Shop-block”, etc. As a new entrant is filling out the registration they must go through the legal document before entering the site. However, set up of the legal document as a game would add interest to the tedious nature of the reading the legal information. Making it fun or quiz-like provides evidence of verification that the player has read it. The player can be rewarded with their first points for applying themselves. Password fields do not allow a player to pass to the next SITE area until all are filled out.

CREDIT CARD APPLICATION—This is the main credit card application page which can either act as a self-contained page with an application that, once filled out, will be forwarded to credit card partner, or be a direct link to the credit card partner's on-line entry. There can be a link to the Rules page as well as the Legal page. Preferably there is a clear stipulation that purchases from within the game's CATALOG require credit or debit card, or parental credit card information. There should also be clear stipulation that abuse of the card within the site (i.e. non-payment) may be punishable with points lost. Successful application for credit can be rewarded with membership, or some other privilege, or, an approved card application gives an automatic membership to some of the more exclusive areas within the SITE. At any point in time that a user wants to buy membership with points, they are warned that auctioning requires purchase with credit card. They are then forwarded to credit application/enrollment where the credit card information is taken (either parents card or other card.).

CATALOG—The catalog section is the primary source of player e-commerce and archiving of data input within “the game”. Although the CATALOG is a component of the SITE, the catalog section data flow is represented in FIG. 2 independently because it is a concentration of data traveling to and from On-Line Players within the SITE, PRODUCTS/SUPPLIERS, and the LIVE SHOW/Development. The catalog section accessible from the Main Page or “home page” and broken into several catalog areas with two key areas creating distinct sections separated by product of past LIVE SHOW Subject Player profiles and by product category. There can be links to product sponsors, pull-down menus for product searches by trait or characteristic, and sections divided into areas showing what was accepted above 50% of the vote by on-line players and what was not. For instance, products and services offered are weeded out by on-line player voting to show what is preferable by majority, but products and services not selected by majority are available for review in a separate product/services area. All products/services shown within the SITE and CATALOG are selected by the producers in tandem with on-line players product voting and evaluation which occurs within the LIVE SHOW Subject Player profile/questionnaire and the auction/merchandise evaluation form. Products/services within the CATALOG can be purchased by players with a credit card, points alone, or a combination of the two. Credit Card/Cash purchases of product within the CATALOG accrue points for the player by a percentage of the total dollars spent.

LIVE SHOW SUBJECT PLAYER PROFILE/QUESTIONNAIRE This is the main interface page for the entry of player feedback during the time, for example the 23 hours, prior to the LIVE SHOW segment. Questions are posted and answered by players as to what they believe will be LIVE SHOW Subject Player's responses during the LIVE SHOW, as well as what they believe would be suitable for the Subject Player, and even themselves. Here, on-line players can access questionnaire responses by their fellow teammates and communicate with them by on-line email or “chat”. The questionnaire will be a mix of entertainment-oriented and merchandise-oriented questions. There will be “surprise” questions that will be asked during the live segment and award special points as an incentive for players to “tune in”. Write-in boxes for additional feedback/dialogue are available to on-line players for additional points. This area of the site is where most of the interactivity occurs. It is preferably be a main page during the majority of the live segment of “the game”. Here, on-line players may experience being brought on-air unexpectedly by way of the TekPak (see FIG. 2). Marketing feedback on products/services as they are evaluated by players can be a button-process in descending order with “hip-phrase” description of acceptance. i.e. “Excellent!”, “Cool”, “It Rocks”, “It Bites”, “Bogus”, etc. The descending order will be the products/services evaluation. “Excellent”=Very High, “Cool”=High, “Bogus”=Poor, etc. This makes for easy voting & tabulation. An additional text dialogue could be supplied, with 20 characters for example, for suggestions of alternate answers not supplied in the choices available or elaboration that could be databased by keywords.

QUESTIONS & MERCHANDISING INPUT—These are the general trivia questions, product questions, suppositional scenarios, and spontaneous LIVE SHOW questions that on-line players answer during their respective on and off-air segments of “the game”. This data is delivered to an informational repository for collating and evaluation during the LIVE SHOW, as well as by suppliers of GOODS AND SERVICES (see FIG. 2).

AUCTIONING & MERCHANDISING FORM—This page is the primary evaluation/voting section on products to be utilized at later dates or subsequent LIVE SHOWS within the LIVE SHOW Subject Player profile/questionnaire and a major source for player interaction/participation for points. It is also the live auction section of the site where SUPPLIERS OF GOODS AND SERVICES might supply a requisite amount of goods and services in exchange for the data that may come with their products posting within this page. Players are able to buy these special products/services in auction at wholesale to retail prices with cash (credit card), cash-points, and points only. This page is a major source of consumer data for suppliers of GOODS AND SERVICES (see FIG. 2). On-line players are rewarded with merchandising points for supplying valid product evaluations. Some auctions may involve exclusive membership to access specific areas for auction unavailable to “non-members”. This might be special product, or products/services at a “members only price”. These memberships can be acquired through redemption of points, credit card purchase, and as a reward for certain participation within “the game” (i.e. New player applies for credit card through Credit Card application within SITE and receives approval. This player could receive instant membership).

TekPak—The Tek Pak Page is preferably accessible from a variety of pages within the site. It is an information/order form for this minivideo cam that is easily installed and an excellent cross-collaborative component of “the game”. It allows the ability to be seen remotely via a standard dial-up modem and allow video conferencing capability. The TekPak manufacturer can supply to on-line players who attain the position of LIVE SHOW Subject Player and allocate quantities that can be sold directly through the manufacturer or its distribution center. The Tek Pak the primary mode of communication with a LIVE SHOW Subject Player and any on-line players who are brought unexpectedly on-air during the live show, preferably one hour long. Tek Paks can be purchased through this page or be made into a membership incentive. For instance, players with special membership can get a special rate on Tek Paks, etc.

HELP LINE—This page is the link to a separate demographic specific, i.e., “help” center, for example, a teen “help” center. It is the connection to a forum for issues, information, chat and other support for teens. Within the site are on-line psychology support or links, educational references, drug rehab links, college profiles, student loan program links, scholarship program links, sexual and family planning, etc. This can also be where on-line help for “the game” may exist. An on-line player of particular rank or LIVE SHOW Subject Player is be on-line to aid in oriented or helping new players in getting oriented with rules and strategies of “the game”.

PRODUCT VOTING AND EVALUATION—This is where individual products and services are accessed and voted upon within the Auctioning & Merchandising page (#9 on FIG. 1). This information is collated from on-line player responses in exchange for merchandising points and subsequently databased and evaluated by the Teen Producers as potential products and services to be featured in later LIVE SHOWS. This information is also data gathered for use by suppliers of GOODS and SERVICES to gain incite on the viability of their products or services within the applied demographic (see FIG. 2).

CATALOG BY LIVE SHOW PLAYER PROFILE—This page is one of two preferred formats in which products are required within the CATALOG, the other being by product category (#14 on FIG. 1). Here, players can review products which have been selected by them, the LIVE SHOW Subject Player, and the Producers of the LIVE SHOW during all 24 hours of the on and off-air segments of “the game”. It is truly the culmination of consumer-approved products/services collated into an e-commerce CATALOG by specific consumer traits/profiles, all of which were determined through the process of players participating in the SITE and the LIVE SHOW (see FIG. 2). As LIVE SHOW Subject Players participate in the on-air segment of “the game”, their personality profile is evaluated and products/services are voted on by players as to what products/services may actually be most appealing or best suited for the Subject Player. Outcomes are established within this segment of the CATALOG and preferably posted where on-line players can shop products/services based on traits of personality, fashion, music, talents, interests, and others. Purchases are by way of credit card, points redemption, or a combination of the two.

CATALOG BY PRODUCT/SERVICE CATEGORY—This page is one of two formats in which to review products and services within the CATALOG, the other being by LIVE SHOW player profile (#13 on FIG. 1). Here, players can review products and services that have been determined by them, the LIVE SHOW Subject Player, and the Teen Producers of the LIVE SHOW during all 24 hours of the on and off-air segments of “the game”. These products and services have proven viability and high appeal toward their demographic due to the method in which they were selected. This method being the determination of these products/services appeal through the participation of the SITE and the LIVE SHOW (see FIG. 2).

PRODUCTS/SERVICES BY PROFILE—These pages are the individual product pages showing past LIVE SHOW Subject Players and their profiles, their profile video and all products/services that were selected by them for themselves, the on-line players selection for the Subject Player, and the percentage of acceptability. Products/services can also be searched by traits/characteristics.

PRODUCTS/SERVICES BY CATEGORY—These pages are the individual product pages showing product by category, and the corresponding percentage of acceptability. Products and services can be queried by a variety of categories such as the type of product or service it is, manufacturer, season, price, sport, fashion, accessory, clothing, technology/electronics, music, entertainment, and many other categories.

FIG. 2 is a diagram showing examples of data flows implemented by the present invention. Referring to FIG. 2, the data flow has clear avenues between each junction point and convergence at the center. The data flows shown in FIG. 2 are described as follows:

A—Data flow between SITE and CATALOG.

Represents the primary avenue of e-commerce and consumer financial transactions as well as the archive of userdefined and sanctioned products and services as resulting from the interaction between the SITE and the LIVE SHOW.

B—Data flow between SITE and PRODUCTS/SUPPLIERS

Represents the to-and-from flow for data to user profiles for vendors by way of credit card partners and the SITE information, TEK PAK hardware vendor, Help Line (#11 in FIG. 1) services, on-line advertising, requests for advertising/celebrity endorsed product, and any product feature/evaluation by On-Line Players, data responses on products featured in auctioning or product evaluation.

C—Data flow between LIVE SHOW and PRODUCTS/SUPPLIERS

Represents to-and-from data gathered and distributed for products/services endorsements, live consumer feedback on products/services as a mass-market focus group, live celebrity endorsements, and approval/denial for endorsement/evaluation from Teen Producers and LIVE SHOW Development in conjunction with data response from On-Line Players at the SITE (Figure B).

D—Data flow between CATALOG and LIVE SHOW

Represents the one way flow of data from the LIVE SHOW to the CATALOG for the archiving of user-defined and sanctioned products and services as resulting from the interaction between the On-Line Players within the SITE, PRODUCTS/SUPPLIERS and the LIVE SHOW.

E—Data flow between CATALOG and PRODUCTS/SUPPLIERS

This flow represents the data gathered within the CATALOG from the SITE to render a viable list of products and services of which have a verifiable level of acceptance by the applied demographic. PRODUCTS/SUPPLIERS informed with this data subsequently responded easily by merchandising product or fulfilling services in demand as the data dictates.

F—Data flow between SITE and LIVE SHOW

This is the data exchanged to and from the tandem operation of On-Line Player responses to questions within the SITE and their interplay/verification within the content of the LIVE SHOW. On-Line Players furnish data, either by way of entry within the SITE or “chime-in” via TEK PAK in exchange for rewards in the form of merchandising points towards GOODS AND SERVICES and other incentives.

G—Data flow convergence of all data flow avenues

The convergence point G serves as an information catalyst and point of translation for data transfer. Within point G, data is exchanged between the various entities cooperating within the present system. Point G dictates the format, configuration, and any other content parameters of the separate elements of the LIVE SHOW, SITE, CATALOG, and opportunities for PRODUCTS/SUPPLIERS, allowing them to operate in tandem to elicit data from the consumers. Point G implemented using a multimedia software “language” or system which coordinates the communication between all separate and outside multimedia to work in a cooperative manner to achieve a specific function. This aspect will be described in greater detail below.

H—Data supplied/entered and accessed by Users/Players

This is the primary source of all data with “the game”. The data flow within H represents all information supplied by On-Line Users/Players (illustrated by “from” of H) from initial LOG-IN (#3 of FIG. 1) to all data entered thereafter. Player profiles, questionnaires, team vote for Subject Player Candidates, or other relevant date is shared within “team members” and returned to Users/Players at their request (illustrated by “to” of H). This is also where e-chat among On-Line Players occurs.

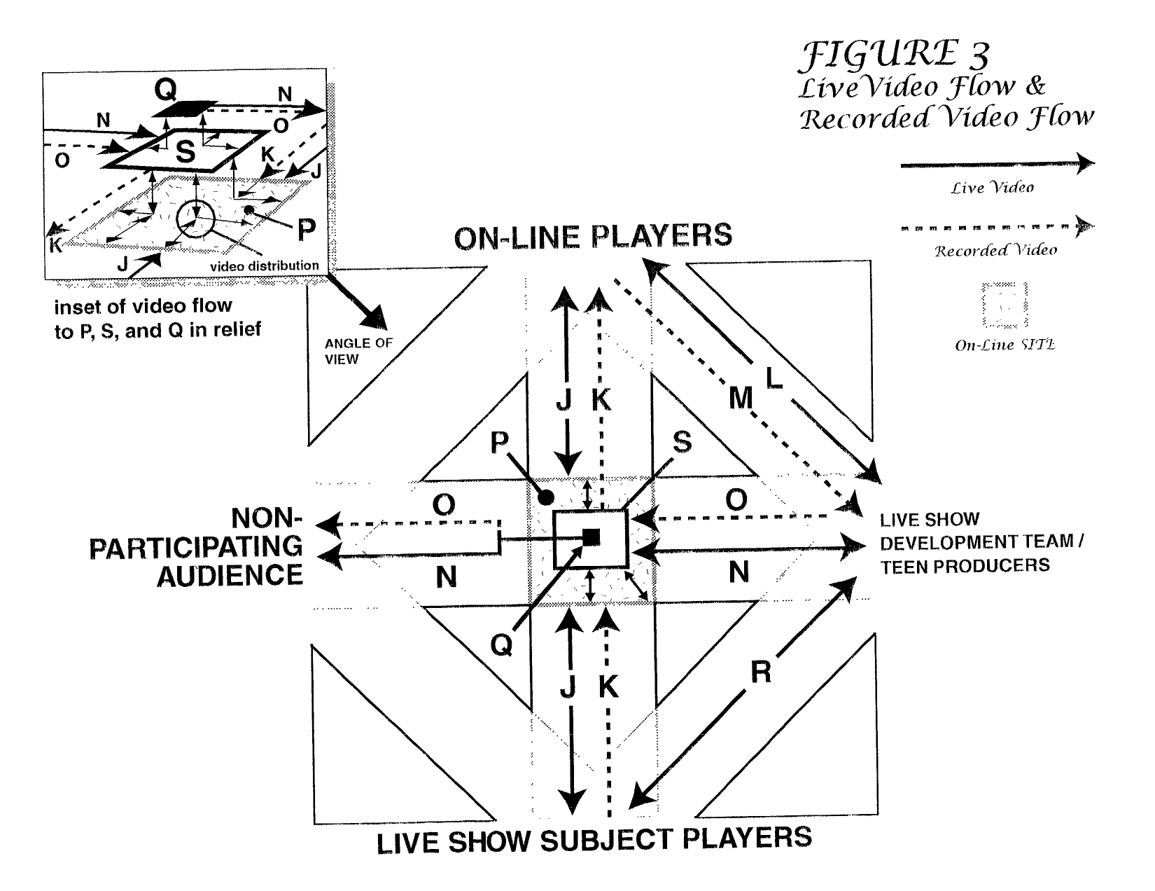

FIG. 3 is a diagram of live and recorded video data flows of the suggested flow of live and recorded video between the On-Line Players, the LIVE SHOW Subject Players, the Non-Participating Audience, and the Producers/Development Team of “the game”. As shown in FIG. 3, the data flow has clear avenues between each key junction point illustrating the video flow, all of which converge to create what becomes “the game”. It should be noted that along with Non-Participating Audience, the On-Line Players may access the LIVE SHOW content by way of conventional television transmission and play the on-line SITE content in tandem via the Internet.

J—Live, two-way video transmission from On-Line Players to SITE and LIVE SHOW Subject Players

This flow is presented in the format of spontaneous on-line player on-air video appearance or “chime-in”. Conversely, LIVE SHOW Subject Players transmit live video as on-air participants of the LIVE SHOW.

K—One-way recorded video transmission from LIVE SHOW Subject Players to SITE and On-Line Players

This flow is presented in the format of profile video reviewed by On-Line Players during the off-air SITE.

L—Two-way live video transmission from On-Line Players to LIVE SHOW Teen Producers

This flow is presented in the form of spontaneous on-air video appearance or “chime-in” by the On-Line Player and conversely from Teen Producers to On-Line Players in the form of LIVE SHOW host, celebrity appearances, product endorsements, and any other LIVE SHOW content that requires live, real-time presentation or response.

M—One-way recorded video submission from On-Line Players to Teen Producers

This flow is presented in the form of LIVE SHOW Subject Player submission profile video, conversely reviewed by Teen Producers and used as content during the on-air LIVE SHOW and off-air SITE.

N—One-way live video transmission of LIVE SHOW content to Non-Participating Audience and On-Line Players via television broadcast or other

This flow is presented in the format of all LIVE SHOW content outside of LIVE SHOW Subject Players and on-line player “chime-in”, namely LIVE SHOW host, celebrity appearances, product endorsements, and any other content that requires live, real-time presentation or response.

O—One-way recorded video transmission of LIVE SHOW content to Non-Participating Audience, LIVE SHOW Subject Players, and On-Line Players via television broadcast or other

This flow is presented including LIVE SHOW Subject Player profile videos, product video, music videos, and hypothetical question video presented as LIVE SHOW content.

P—Representative of information vehicle and convergence referenced throughout the embodiment as SITE

The key point of interactivity outside of the LIVE SHOW, the SITE is the receptacle and distribution point for incoming and outgoing live and recorded video to various areas of “the game”. (See Inset in FIG. 3).

Q—One-way live video transmission to Non-Participating Audience.

This transmission is for those who do not take part in the interactive component of “the game” but wish to watch as it takes place. The transmission is preferably supplied by conventional television signal, cable access digital broadcast satellite (DBS), and the like. The same access would supply On-line Players live television transmission to interact in tandem with the SITE, if this were the preferred format of “the game”. (See Inset in FIG. 3).

R—Two-way live video transmission from Producers to LIVE SHOW Subject Players

This would essentially be TEK PAK two-way integrity testing in preparation for LIVE SHOW broadcasting.

S—This is the convergence point of all live and recorded video transmissions.

It is referenced throughout the embodiment as the LIVE SHOW. (See Inset in FIG. 3).

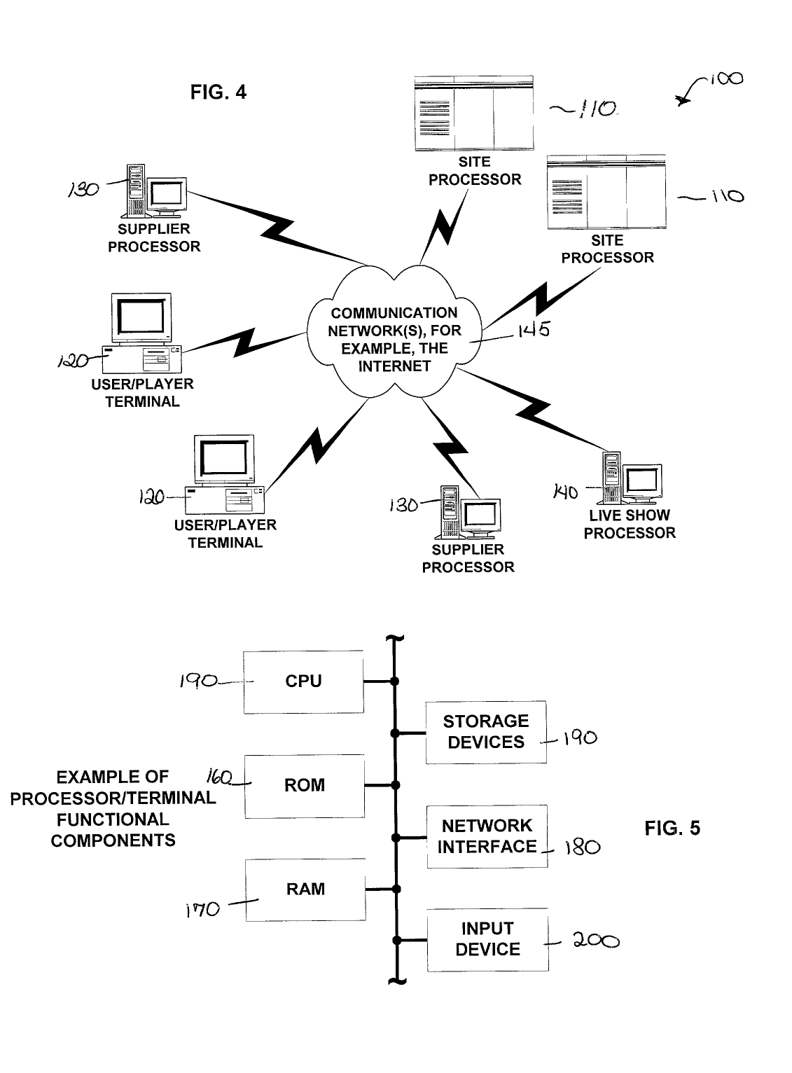

Referring now to FIG. 4, that Figure is a diagram of an example of the hardware components of a network based marketing system constructed in accordance with the principles of the present invention. Marketing system 100 is preferably comprised of one or more site processors 110, one or more user/player terminals 120, one or more supplier processors 130, one or more LIVE SHOW processors 140 coupled together through communication network 145.

Although shown as a single communication network, communication network 145 can be comprised of multiple interconnected networks, for example the Internet. As such, communication network 145 can be any communication network, but is typically the Internet or some other global computer network. Communications between the elements of marketing system 100 can be implemented using any known arrangements for accessing communication network 145, such as dial-up serial line interface protocol/point-to-point protocol (SLIP/PPP), Integrated Services Digital Network (ISDN), dedicated leased-line services, broadband (cable) access, frame relay, Digital Subscriber Line (DSL), asynchronous transfer mode (ATM) or other access techniques.

User/Player terminals 120 have the ability to send and receive data across communication network 145, and the ability to display the received data on a display device using appropriate communication software such as an Internet web browser. By way of example, terminal 120 may be a personal computer such as an INTEL PENTIUM-based computer or an APPLE MACINTOSH computer, but is not limited to such. Other such terminals which can communicate using a global computer network such as palm top computers, personal digital assistants (PDAs) and mass-marketed Internet access devices, i.e., WEB TV, can be used.

Accordingly to the present invention, user/player terminals 120 provide access to supplier processor 130, site processor 110 and LIVE SHOW processor 140 for the purpose of accessing the above-described functionality relating to the game, catalog, auctioning and other aspects of the present invention.

System software which controls the above-described functions relies primarily on one or more site processors 110. Site processors 110 typically communicate with network 145 across a permanent i.e., unswitched, communication link. Permanent connectivity ensures that access to server 110 is always available to terminals 120, supplier processors 130 and LIVE SHOW processors 140.

Site processors 110 can be any appropriately sized computing platform, the storage, processing and other functional capacities of which are determined based on expected user activity and data storage requirements. For example, site processors 110 can be server-type personal computers, mini-computers such as UNIX-based servers, and even mainframe computers.

Supply processors 130 are preferably owned and maintained by the entities of supplying goods and services for marketing. Supply processors 130 are preferably used for receiving demographics, marketing and sales data from site processors 110 and for providing corporate, product and service and other relevant information to site processors 110, terminals 120 and LIVE SHOW processors 140. Further, orders for goods and services placed by users via user/player terminal 120 can be accepted directly from user/player terminals 120 or via site processors 110 (in the case where users placed orders via site processors 110).

LIVE SHOW processors 140 are typically located at the production facility for the LIVE SHOW and are used to facilitate the broadcast and transmission of the LIVE SHOW. For example, LIVE SHOW processor 140 can receive data from a site processor 110 via communication network 145 and can also be used to provide instructions to site processor 110 regarding questions, demographic data and to receive responses from on-line players. In other words, aspects of the LIVE SHOW which require communication with the other elements of system 100 can be implemented on LIVE SHOW processor 140. In addition, where the LIVE SHOW is being broadcast via cable, DBS or traditional broadcast television methods, additional equipment (not shown) known in the art of television production is incorporated within system 100. This equipment includes, television cameras, production equipment, communication links, etc.

As shown in FIG. 5, the functional elements of each site processor 110 preferably include a central processing unit (CPU) 150 used to execute software code in order to control the operation of the server, read only memory (ROM) 160, random access memory (RAM) 170, at least one network interface 180 to transmit and receive data to and from other computer devices across communication network 145, storage devices 190 such as a hard disk drive, floppy disk drive, tape drive, CD-ROM, DVD-ROM and the like for storing program code, databases and application data, and one or more input devices 100, such as a keyboard and mouse.

The various components of site processor 110 need not be physically contained within the same chassis or even be located in a single location. For example, the database on storage device 190 may be located at a site which is remote from the remaining elements of site processor 110, and may even be connected to CPU 150 across communication network 145 via network interface 180.

Terminals 120, supply processors 130 and LIVE SHOW processor 140 are preferably comprised of the same or subset of the functional components described with respect said processors 110. Of course, the functional components of these devices are sized to accommodate capacities appropriate for their usage. For example, terminals 120 may include more sophisticated displays and display driving hardware than the other elements, but may contain a smaller storage device, and less powerful CPU 150 than the other components. Also, supplier processor 130 may contain a more powerful CPU 150 than site processor 110, especially in the case where supplier processor 130 is implemented by a large corporation with a sophisticated Internet presence. Also, the above-described TekPak are typically attached to a known interface on user/player terminal 120 (not shown), for example a serial port, parallel port or universal serial bus (USB) port.

The nature of the invention is such that one skilled in the art of writing computer executable code (software), will be able to implement the described functions using one or a combination of popular computer programming languages such as “C++”, Visual Basic, Java or HTML and/or web application development environments. As discussed above, one of the functions performed by said processors 110 is that of operating as a “web site”.

A web site typically communicates with web browsers using the hypertext transfer protocol (HTTP) to send and receive data including hypertext mark-up language (HTML) web page data and executable JAVA Applets. Of course, any known data transfer protocol and web site configuration/definition language can be used to implement the system 100.

As described herein, references to displaying data on user/player terminal 120 refers to the process of communicating data to the terminal across communication network 145, and processing the data such that the data can be viewed on the terminals of screen using Internet web browser software. Although the present invention is described by way of example herein in terms of a web based system using web browsers and a site processor 110, system 100 is not limited to that particular configuration. It is contemplated that system 100 can be arranged such that terminals 120 can communicate with, and display data received from, the other elements of system 100 using any known communication and display method, for example, using a non-Internet browser WINDOWS viewer coupled with local area network protocol such as Internetwork Packet Exchange (IPX).

Referring now to the above-described Figures, the following is a general description of the present invention and the involvement of an interactive SITE, a live episodic television program or LIVE SHOW (as it will be referred to in this preferred embodiment,) and how the flow of data (as shown in FIG. 2) converges during participants' interaction with the SITE and the SHOW, providing new data exchanged between providers of PRODUCTS AND SERVICES and selected consumers (as referenced by point G in FIG. 2).

The accompanying illustration (FIG. 2) demonstrates the new pathways of data formed by way of the present invention to create a new marketing “intersection” of information. Further, a portion of the data demonstrated is directly elicited by aspects of the present invention; specific data that might not otherwise have been compiled. FIG. 2 illustrates the method of converging data from separate and outside sources in a structured process to establish a common understanding between these variables to work congruently to access demographic specific data.

The method of the present invention is described from the point of a new participant or “player” registering after encountering knowledge of the ability to interact within the vehicle of the invention, heretofore referred to as “the game”, either through conventional promotion or existing player “recruitment.”

The indicated SITE as shown by H of FIG. 2 and FIG. 3 that the player accesses is an entertainment/e-commerce/communication vehicle which rewards player participation with merchandising points that can be redeemed within the SITE through an on-line CATALOG of player-determined PRODUCTS AND SERVICES. The player enters the registered URL address of the SITE, for example, and encounters a log-in page (#3 of FIG. 1) where entry is accessible as a new member only through the registration of specific information. This information enables the building of a user “profile” which can be placed into a profile “repository” (This data contact is illustrated by H of FIG. 2). The new player completes response fields that relate to legal disclaimers (#4 of FIG. 1) and rules of the site (#2 of FIG. 1). Preferably, these fields will not advance to a subsequent field without completely filling out the requested information, but offer rewards in the form of merchandise points as they are completed. Returning players simply log in using their registered player name and password at the log-in page, allowing them to advance to the primary SITE page.

Upon successful completion of the entry form and review of the rules and legal disclaimers, new players are assigned to a block having a predetermined number of players, preferably twelve players. It should be noted that some of these players may have been recruited by other members. Registered players meeting site participant performance requirements may recruit new members and are subsequently rewarded with merchandising points for their successful recruitment efforts. These players preferably have communication capability with each other by way of e-chat 24 hours a day and are only able to access relative profile information that would not divulge irrelevant identity/personal information. As “team members” they are encouraged to interact through e-mail and supposition through each other's profiles (within H of FIG. 2) and questionnaire responses (#7 of FIG. 1). On-Line Players preferably receive merchandising points for profiles reviewed. These team members, through interaction and collaboration, select a member amongst themselves to be proposed as a LIVE SHOW Subject Player candidate and possibly rewarded with merchandising points for their collaborative effort. This player, if selected, will vie for points and prizes for himself and his team members. The intent is to foster a teamwork mentality and encourage these players to help each other to achieve a common goal, which is the ascension of rank and status within the structure of “the game”.

Ascending ranks are attained by amassing points achieved by participating in “the game”, recruiting and aiding players, purchasing products, and other methods which revolve around participant collaboration and selected site participation. As players begin at the lowest level, various levels of ascension through accumulation of points preferably brings special privileges. Examples of these privileges include (1) access to special auctions; (2) special discount programs for merchandise; (3) exclusive memberships to areas of the site which are reserved for “members only”; (4) permission to submit a profile video for consideration as a LIVE SHOW Subject Player, meaning those who become featured personalities of the show segments (video submission being avenue M of FIG. 3); and (5) unannounced inclusion in the LIVE SHOW, among other options. This video is reviewed by the Producers of the show and, if selected, is posted within the LIVE SHOW Subject Player questionnaire on the SITE (#7 of FIG. 1) for review by On-Line Players (avenue K of FIG. 3). The video helps On-Line Players get a sense of the LIVE SHOW selected Subject Players and the opportunity to respond to the questions designed for that Subject Player (avenue J of FIG. 3).

Registered players at the highest levels are preferably considered to co-host a LIVE SHOW broadcast or become a “Producer” and actually help in the development and production of “the game”. It is important to note that the target demographic that the present invention strives to reach and sample is involved in all aspects of producing the LIVE SHOW multimedia venue.

The points system within “the game” rewards players for their participation, input, incentive, purchases, positive feedback, entertaining responses, help with other players, and recruitment of new players. Points for purchases can be issued in accordance with the site providers' reference, but is preferably a percentage of the overall currency, i.e., dollar purchase. For example a $100 purchase could yield a 10-point reward.

“The game” is designed to have merchandising elements of a high appeal within the applied demographic within it. As such, players are preferably encouraged to access a credit card application (#5 of FIG. 1), preferably within the log-in page. This credit card, available through an established credit card partner, can be secured either through standard verification of players credit records, or through parent sanctioning through co-signing (this data is a component of B in FIG. 2). With a parental co-sign, the option for a CATALOG “shop-block” can be exercised to curtail the buying privileges of the player for whom the parents had co-signed. The credit card promotion demonstrates one of the powerful vendor partnership potentials within the site allowing for a focused promotion between the target demographic and a credit provider.

Upon advancing to the primary SITE page (#1 of FIG. 1), players have access to the core elements of the LIVE SHOW (conduit F on FIG. 2), the SITE, and the CATALOG (conduit D on FIG. 2). Players are essentially at the interactive starting point component, designated as SITE in FIG. 2. Available at this location are pages to order a video hardware component, heretofore referred to as the TekPak, (#10 of FIG. 1 and avenue B of FIG. 2) that allows the possibility of players to experience live, network-driven, two-way, real-time video interaction with the LIVE SHOW itself (avenue J of FIG. 3).

The TekPak aspect of the present invention demonstrates yet another important vendor-partnership potential within the SITE and as an aspect of the invention, allowing for a valuable technology partner relationship by providing “site-show” compatible hardware to site participants desiring to interact visually within the multimedia venue of this invention.

As described above, the present invention also provides access to a personal Help-Line (#11 of FIG. 1), a link to the LIVE SHOW (by way of conduit F on FIG. 2 and as controlled by Producers derived from the ranks of past site participants) and a profile-driven CATALOG of merchandise (#13 of FIG. 1 and information flow illustrated by way of conduits A and D on FIG. 2). Within the aforementioned Help-Line, players can seek out and arrange for educational services, career counseling, drug and alcohol rehabilitation centers, sexual and pregnancy counseling, college information links and databases, and other emergency help options for players who may not have acceptable access to these services.

In terms of a 24-hour day and supposing a daily one hour show, players have 23 hours of access to questions and profile video within the SITE relating to the content of the upcoming one-hour LIVE SHOW segment (component of Flows F, B, and C on FIG. 2 and Flows K of FIG. 2). These questions/video reside and are responded to on the LIVE SHOW candidate participant page (#7 of FIG. 1). The LIVE SHOW segment will feature two Subject Players, or LIVE SHOW players, who have been elevated to, a level within “the game” such that that they are eligible for substantial rewards, barring the interactive outcome between the LIVE SHOW and participating On-Line Players (avenue F of FIG. 2). These particular Subject Players have earned the opportunity to appear on the LIVE SHOW as the result of several circumstances: 1) they may have earned a requisite quantity of points through participation in the SITE; 2) they may have been notable in the recruitment of additional players to “the game”; and 3) they may have been elected by their peers to represent them on the LIVE SHOW (an activity occurring within H of FIG. 2). With the advent of these circumstances, a potential LIVE SHOW Subject Player candidate is notified by the deciding Producers of the LIVE SHOW that they may submit a video for consideration to participate in the LIVE SHOW (avenue M of FIG. 3). If the Subject Player candidate's video is selected, they are then notified that they will participate remotely via live video through the aforementioned interactive video camera (TekPak) for the potential of substantial prizes (flow F of FIG. 2 and flow J of FIG. 3). Naturally, in the example of a teen-based game, a business framework of adult executive producers would create the environment for the teens to create and “program” the LIVE SHOW, though the teens would be regarded as the “editors” (not unlike a magazine which may have its editorial staff and its business and operations staff, often referred to as the publishing staff).

The SITE is configured to work in tandem with the production of the LIVE SHOW and is designed to solicit and reward responses from participating On-Line Players which will be addressed during the content of the LIVE SHOW (avenue F of FIG. 2). Some of the questions are engineered for their value in evaluating products and services that the Producers have selected for inclusion in the programming for a host of SUPPLIERS OF GOODS AND SERVICES who have “requests for consideration” into the show (avenue B of FIG. 2).

The present invention is preferably arranged such that On-Line Players can vote on what commercials may actually be aired during the LIVE SHOW through viewing the commercial video residing on the SITE (avenue K of FIG. 3 and aspects of avenues F, E, and C of FIG. 2) adding further product evaluation to SUPPLIERS OF GOODS AND SERVICES. On-Line Players have the possibility of being rewarded merchandise points, should that player's responses have a favorable result relative to the outcome of the LIVE SHOW segment. Preferably, LIVE SHOW players have even greater prizes to attain if they achieve a favorable outcome during the LIVE SHOW.

During the remaining, i.e., 23, hours of “off-air” time prior to the LIVE SHOW, participating On-Line Players preferably answer multiple choice questions of an entertaining nature directly relating to the LIVE SHOW Subject Players and other content (#7 of FIG. 1). Players can also respond in data fields capable of accepting and recognizing key words that can be easily sifted for storage in a database. These questions are engineered to elicit information that would then be collated and stored in a database as response information relating at times directly to products and services. Subsequently, a viable products/services list is returned for display within the on-line CATALOG or subsequent LIVE SHOWS (avenues C and E of FIG. 2). It also serves as viable data to SUPPLIERS OF GOODS AND SERVICES, as the product data gathered is directly selected by the members of the given demographic resulting in immediate verification of the high levels of acceptance by that demographic (avenue E of FIG. 2).

The CATALOG integrity gains an advantage due to the existence of the site data, ensuring that the feedback on items featured within the CATALOG creates further potential interest in the selected items featured by the purchasing demographic (Flow A of FIG. 2).

On-Line Players may peruse or browse this on-line CATALOG in several manners including product by Category or as product by LIVE SHOW Player Profile (flow A of FIG. 2). All products are essentially items that have been reviewed by both On-Line Players and LIVE SHOW Subject Players and selected by popular vote through responses gathered within the LIVE SHOW Player Profile Page (#7 on FIG. 1) and revealed during the LIVE SHOW (Flow F of FIG. 2). These catalog pages may include visuals and/or actual video of the selected player on which referenced pages are indexed, as well as selected “reply” show content from the LIVE SHOW segment in which the player appeared.

Data supplied by players at the SITE level are stored in the database and confirmed during the LIVE SHOW (flow F of FIG. 2) and subsequently applied into a verifiably “consumer approved” on-line CATALOG. This CATALOG can be reference/queried by product category or personality traits/profile, or other variables specific to occurrences within the corresponding LIVE SHOW segment (flow D of FIG. 2). Any purchases or financial transactions of items within the CATALOG are preferably accomplished either by credit card, redemption of site merchandising points, or a selective combination of the two (flow A of FIG. 2). Players with special privilege memberships may have access to products or discounts not available to players outside of the membership or may have early notice of goods and options, among other possible incentive rewards for selected players.

The LIVE SHOW is the focal point of the greatest concentration of interactivity among all facets of “the game” (S in FIG. 3). After all variables such as LIVE SHOW Subject Player TekPak transmission has been verified to have integrity (flow R on FIG. 3), the LIVE SHOW goes “on-air”. On-Line Players can play along viewing the LIVE SHOW transmission either through the SITE itself or also simultaneous as a television broadcast, DBS broadcast, cable telecast, etc., (Flow J of FIG. 3). Clearly, the LIVE SHOW might have a non-participating viewing audience distinct and additional to the On-Line viewers/players of the LIVE SHOW (Flows N and O of FIG. 3). It should be noted that the LIVE SHOW preferably incorporates selected pre-recorded elements as well, within its content. The LIVE SHOW Subject Players are brought on-air selectively by way of the aforementioned TekPak and subsequently become the focus of attention as the questions which reside within the player questionnaire pertaining to that show episode are reviewed (Flow J of FIG. 3).

On-Line Players are encouraged to get a sense of the personality/characteristics of the LIVE SHOW Subject Player, as the questions are generally about them. Some questions are general trivia and supposition-style life-choice scenarios, while other questions are based on fashion, personal likes/dislikes, interests, romance, style, talent, and other traits/characteristics/persona-oriented questions that help On-Line Players answer questions that revolve around the LIVE SHOW Subject Player. Some questions are asked at the time of the LIVE SHOW to add spontaneity. At times, actual product is introduced during the LIVE SHOW, possibly by way of a celebrity endorsement brought on-air live via a TekPak, with the intent of establishing the products'application and appeal to the Subject Player and On-Line Players (Flow C in FIG. 2).

At other times, market data questions allowed by the Producers are integrated into the LIVE SHOW which relate to the featured Subject Player, or may be an addendum to other questions. This perpetuates the data-specific business of the site within what the Producers will allow to maintain show and context integrity from their point of view, as members of the target demographic.

The responses to most of the questions by the On-Line Players are tallied in advance of the LIVE SHOW during the 23-hour period preceding the show. The responses to a majority of the questions by the Subject Player have been calculated in advance as well in order to engineer specific questions and products in which to feature during the LIVE SHOW. A host or “MC” presides over the interaction between the On-Line Players and the Subject Player during the LIVE SHOW. On-line player responses submitted at the SITE level are compared to those responses by the LIVE SHOW Subject Player during the LIVE SHOW for points and prizes. As mentioned previously, On-Line Players are prompted for “write in” responses for additional points in addition to being rewarded if their relative multiple choice response was correct. These valuable subjective “write-in” responses provide banks of consumer data by keyword for featured products and services (Flow C of FIG. 2). For example, a designer can have a new line of outerwear reviewed instantly and in detail by a few simple audience prompts and corresponding feature on the show. New potential suppliers may be identified by way of these “write in” responses as well, drawing on the Internet audience for a wealth of options and possibilities beyond the knowledge of the producers.

The LIVE SHOW is engineered to incorporate player interactivity on multiple levels. As such, On-Line Players equipped with TekPaks can be brought on-air by way of their own live video and audio transmissions, referred to as a “Chime-In”, to participate in the SHOW at the discretion of the Producers (Flow L in FIG. 3). This adds an anticipation element at the On-line Player level by suddenly being personally involved in the LIVE SHOW on a global basis, preferably without warning. During the show, players from around the world may be “pulled” into the show, in instances simply as facial reaction shots with their screen names visible, and selectively according to aspects of their performance on the site. Combined audio may allow for a collective worldwide “studio audience” reaction sounds within the show as well.

Just as On-Line Players can be brought in through live transmission, the aforementioned possibility of integrating surprise guests and special appearance celebrities to endorse or promote a product, or participate in the LIVE SHOW in some other manner is another aspect of the present invention (Flow C of FIG. 2). Promotional appearances, as determined to be context appropriate by the Producers, can be accomplished using the TekPaks. This allows special guests to appear from home without the need for a satellite link or special travel to remote studio locations and without the need for excessive lead time arrangements (Flow N and J in FIG. 3). Those special guests needing information to promote a product or service may be given access to the demographic data (flow E of FIG. 2), given that the Producers, in tandem with the On-Line Players input (Flow B in FIG. 2), deem them and/or their promotion relevant and useful to the show's content or the featured players' profiles and preferences (Flow C in FIG. 2). This access is quick because the information can be transmitted to the special guest using the communication network, preferably by transmitting the information to the special guest's computer.

Because products and services play a large role in the LIVE SHOW, auctions for products at special prices may occur at the auction page (#9 in FIG. 1). Here, On-Line Players may bid on products with points, cash, or a combination of the two. On-Line Players at particular levels who have achieved special memberships, or players who have purchased a membership with the redemption of earned merchandising points outright, may have exclusive access to certain auctions or paying privileges. For instance, these players may have the right to purchase an item with points only, or to receive special discounts on products that players outside of the membership would likely not receive at the discounted rate. On-Line Players may also evaluate product for points within this page (An aspect of flow B in FIG. 2). The information is stored in the database for selected paying suppliers of Goods and Services and reviewed by the Producers to determine products which may be integrated into subsequent LIVE SHOWS (Flow C in FIG. 2) based on popularity.

The LIVE SHOW progresses as Subject Players' responses are compared against On-Line Player responses to the same question and are awarded with prizes as their responses are confirmed with a majority percentage agreement with the On-Line Players (Flow F in FIG. 2). At the conclusion of the LIVE SHOW, Subject Players with enough favorable responses to place them in a “Winner” category will elevate themselves to a new level of player contention in which they are eligible to become a possible Co-Host for a day during a subsequent LIVE SHOW. They are in contention, for instance, for the Grand Prize which is awarded at the end of an allotted time period. For example, this Grand Prize may be education related i.e., a year of tuition at a school partnered with the LIVE SHOW. They may further become an intern functioning at the production facility or remotely as a Producer of the LIVE SHOW as well, depending on the player's level of collaborative involvement with his fellow team members or other players as a “Help” resource within the Help Line (#11 on FIG. 1). In the instance of a “teen show”, those Producers acting as Teen Producers are selected from the top performers by the existing Teen Producers and can be paid short-term jobs.

The LIVE SHOW Subject Player who wins during the LIVE SHOW also wins points and prizes for his team members as well. This is because they worked together to elect this player to represent them collaboratively. As mentioned, LIVE SHOW players who “graduate” by winning the game may potentially continue within the game with a new role as a “guide.” This option changes the basis of their points earnings to include providing “help” services to other Internet players, specific to the logistic and nuances of the site, game and LIVE SHOW. Another option is that “winners” graduate entirely, leaving the game. This “closure” further extends the educational aspect of the game, demonstrating another valuable aspect of life outside the game, where graduation means moving on to other activities.

It also noted that the potential for a “maximum” number of players each day might provide further incentives for players to meet criteria, including the completion of the needed answers for a day's program, to both further ensure the “special” aspect of being a player in a given day and to simplify the guaranteed number of interacting players each day (with a number guaranteed to be reached.) Knowing exactly how many will play is also a promotional point of the site regarding data sampling services promotion and other related advertising and site services evaluation.

It should be noted that the value of the consumer data elicited by the present invention is increased by the immediacy of the data being compiled through the live interaction. This interaction also improves the potential accuracy of the data.

A specific example of an implementation of the present invention is explained as applied to a TEEN demographic market using a theme of a prison system or society encompassing “the game”. As such, the following parallels and terminology are applied to this example:

Upon logging in as a new entry or existing entry, On-Line Users or Players as listed are essentially “processed” into the SITE through the Log-in page and are referred to as “Inmates”. All new Inmates are assigned to a “Cellblock” of twelve fellow inmates, all working collectively to attain “Parole”, a high level of achievement within the “game”. To do so, Inmates may advance to higher levels or titles either through the process of point accumulation, promotion by their fellow cellblock inmates, or by way of any of the methods listed described above. Each level holds different privileges and titles. For example, Librarian, Foreman, Yard Boss, Cook, etc. During game play, each level is color coded for easy reference.

Upon reaching an appropriate level of achievement, permission may be granted to submit a profile video by the Producers of the game's LIVE SHOW. The Inmate submits a profile video in the hope he or she can become a LIVE SHOW Subject Player, referred to as a “Parole Candidate” or “PC”.

The process of data entry within the SITE of the game takes place primarily during the 23 hours prior to broadcast of the LIVE SHOW, heretofore referred to as “Lockdown”. Inmates fill in responses and verify during the one hour LIVE SHOW broadcast of the game by pitting their data against the data of the featured PCs of the day. Inmates may be called in spontaneously to supply feedback via the TEK PAK during the LIVE SHOW, referred to as “Shakedown”, but may be censured for negative response, foul language or other reasons, incurring a period of punishment or point reduction, referred to as “Solitary”.

All activities during the LIVE SHOW period are governed by the LIVE SHOW Host referred to as the “Warden”. He/she is not a Player. Preferably, the “Warden” is a professional actor, arbitrating the action between all elements which make up the LIVE SHOW. However, PC's who achieve parole through agreeable performance in relation to On-Line Inmate responses and a positive vote to advance the PC at the conclusion of the day's game can attain a higher level of achievement in the game as a “Co-Warden” for a day. This occurs only as the paroled Inmate continues to aid in the game and the other game Inmates through a post-parole society that revolves around the concept of collaboration and teamwork. The highest level for a paroled Inmate is the “Teen Producer” level, where they can work in tandem with Executive Producers to actually coordinate the production of the LIVE SHOW and other aspects of the game's SITE.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An interactive network-based marketing method comprising:
arranging a web site and a television broadcast in the form of a game;
capturing marketing data from web site users; and
promoting products and services which correspond to the captured marketing data via the web site or the television broadcast.

2. The method according to claim 1, wherein the television broadcast is programmed according to the marketing data captured from the web site users.

3. The method according to claim 2, wherein the programming of the television broadcast is determined in real-time in response to the captured marketing data.

4. The method according to claim 1, further comprising:
cataloging the products and services corresponding to the captured marketing data.

5. The method according to claim 4, wherein the captured marketing data includes user trait-related data and user preference-related data, and the products and services are cataloged according to the user trait-related and user preference-related data.

6. The method according to claim 5, further comprising:
enabling the cataloged products and services to be browsed by the web site users.

7. The method according to claim 6, wherein the cataloged products and services are browsed by one of the user trait-related data, the user preference-related data or both the user trait-related data and the user preference-related data.

8. The method according to claim 4, further comprising:
facilitating the purchase of the cataloged products and services by the web site users.

9. The method according to claim 4, further comprising:
auctioning the cataloged products and services to the web site users.

10. The method according to claim 9, wherein the cataloged products and services are auctioned to web site users having marketing data similar to that of the cataloged products and services to be auctioned.

11. The method according to claim 1, further comprising:
deriving revenue from the web site users.

12. The method according to claim 1, further comprising:
deriving revenue from the sale of the captured marketing data.

13. The method according to claim 1, further comprising:
deriving revenue from the promotion of the products and services.

14. The method according to claim 1, wherein the web site users are television broadcast participants in the game.

15. The method according to claim 14, wherein the television broadcast participants are selected by the web site users.

16. The method according to claim 15, wherein the television broadcast participants are selected from the web site users.

17. The method according to claim 16, wherein the participants are selected from the web site users logged-on while the television broadcast is transmitted.

18. The method according to claim 1, wherein the web site users are audience members of the television broadcast.

19. The method according to claim 1, wherein the web site users earn credit towards the purchase of the promoted products and services.

20. The method according to claim 1, wherein the marketing data includes video and audio of the web site users.

21. The method according to claim 1, wherein the web site and the e t television broadcast are based on a specific demographic.

22. The method according to claim 1, wherein the marketing data i s captured in real-time.

23. The method according to claim 1, further comprising:
transmitting the television broadcast to the web site users in real-time.

24. The method according to claim 23, wherein the television broadcast is transmitted to the web site users while the game is being played.

25. The method according to claim 1, wherein the web site users collaborate toward a common goal of the game.

26. The method according to claim 1, wherein the web site and the television broadcast cooperate to promote the products and services.

27. The method according to claim 1, further comprising:
posing questions to the web site users during the television broadcast; and
receiving responses to the questions.

28. The method according to claim 27, wherein the questions and responses are utilized in the promotion of the products and services.

29. The method according to claim 1, further comprising:
broadcasting the game in real-time on the web site.

30. The method according to claim 29, wherein the game is further broadcast by conventional telecasting techniques.

31. A marketing method for constructing a multimedia venue which elicits response data from consumers, the method comprising:
providing a live television program;
providing an interactive Internet site; and
linking the television program and the interactive Internet site via a communications network,
wherein users of the Internet site selectively affect content within the live television program, and the live television program is produced to function in tandem with the Internet site.

32. The method according to claim 31, further comprising:
providing an electronic commerce catalog; and
linking the television program, the electronic commerce catalog and the interactive Internet site via the communications network,
wherein the live television program functions in tandem with the Internet site such that the content of the television program determines the content of the as lo electronic commerce catalog.

33. The method according to claim 31, wherein the Internet site is programmed to mutually exchange selected text, video and audio data between users of the Internet site.

34. The method according to claim 31, further comprising:
coordinating products and services to be selectively featured within the content of the site and the television program.

35. The method according to claim 34, wherein the products and services to be featured are selected based on data from participants of the television program.

36. The method according to claim 34, wherein the products and services featured are offered for purchase to the Internet site users.

37. The method according to claim 31, wherein the electronic commerce catalog is archived after completion of an episode of the television program.

38. The method according to claim 37, wherein the archived catalog includes an accessible index for searching the catalog by content categories which pertain to aspects of episodes of the television program.

39. The method according to claim 31, wherein the electronic commerce catalog is indexed according to traits of the users of the Internet site.

40. The method according to claim 31, wherein the electronic commerce catalog is indexed according to preferences of the users of the Internet site.

41. The method according to claim 31, wherein the electronic commerce catalog is indexed according to traits and preferences of the users of the Internet site.

42. The method according to claim 41, wherein the electronic commerce catalog is searchable by one of traits, preferences or traits and preferences of the users of the Internet site.

43. The method according to claim 31, wherein the users of the Internet site are participants in the television program.

44. The method according to claim 43, wherein the participants in the television program are featured visibly and audibly.

45. The method according to claim 43, wherein the participants in the television program accrue credits by transmitting data across the communications network.

46. The method according to claim 45, wherein the credits have a redeemable value within the Internet site.

47. The method according to claim 45, wherein the credits have a redeemable value within the electronic commerce catalog.

48. The method according to claim 45, wherein the credits are further accrued based on data received from the users of the Internet site.

49. The method according to claim 48, wherein the credits are further accrued by assisting other participants in the television program.

50. The method according to claim 43, wherein the Internet site includes messaging and chat software which enables the interaction between the participants of the television program.

51. The method according to claim 43, further comprising:
providing the participants in the television program with questions; and
receiving answers to the questions.

52. The method according to claim 51, wherein the received answers to the questions are used to elicit responses from the users of the Internet site.

53. The method according to claim 43, wherein at least one participant in the television program is featured by way of live two-way video interaction with the Internet site and the television program.

54. The method according to claim 43, wherein the participants in the television program advance within a hierarchy.

55. The method according to claim 54, wherein the hierarchy is a multi-level incentive model system.

56. The method according to claim 43, wherein participants in the television program receive bonuses in the form of selected free products and services.

57. The method according to claim 31, wherein the Internet site includes links to informational and instructional databases.

58. The method according to claim 31, wherein the television program is transmitted to viewers via conventional telecasting techniques across the communications network.

59. The method according to claim 31, wherein the television program is transmitted to viewers via real-time video data transmission across the communications network.

60. The method according to claim 31, wherein the Internet site includes messaging and chat software which enables the interaction between the users of the Internet site.

61. A method for eliciting consumer data, comprising:
providing an interactive pathway;
providing a television broadcast configured to interact via the pathway;
receiving consumer data from one or more consumers via the pathway;
receiving information representing products and services from suppliers via the pathway; and
cataloging the information representing the products and services based on the received consumer data.

62. An interactive network-based marketing system comprising:
a communications network;
a web site linked to the communications network; and
a television broadcast linked to the web site via the communications network,
wherein marketing data is received by the web site via the communications network, and the marketing data is used to promote products and services corresponding to the marketing data via the web site or the television broadcast.

63. The system according to claim 62, wherein the television broadcast is in the form of a game.

64. The system according to claim 62, wherein the television broadcast is programmed according to the marketing data received.

65. The system according to claim 62, further comprising:
an electronic commerce catalog linked to the web site and containing the products and services corresponding to the marketing data.

66. The system according to claim 65, wherein the products and services in the electronic commerce catalog are capable of being browsed by users of the web site.

67. The system according to claim 66, wherein the products and services in the electronic commerce catalog are capable of being purchased by the web site users.

68. The system according to claim 66, wherein the web site is configured to auction the cataloged products and services to the web site users.

69. The system according to claim 68, wherein the cataloged products and services are auctioned to web site users having marketing data similar to that of the cataloged products and services to be auctioned.

70. The system according to claim 62, wherein users of the web site are audience members of the television broadcast.

71. The system according to claim 62, wherein the marketing data includes user trait-related data.

72. The system according to claim 62, wherein the marketing data includes user preference-related data.

73. The system according to claim 62, wherein the marketing data includes user trait-related and user preference-related data.

74. The system according to claim 62, wherein the web site and the television broadcast are based on a specific demographic.

75. The system according to claim 62, wherein the marketing data is received in real-time.

76. The system according to claim 62, wherein the users of the web site are television broadcast participants in the game.

77. The system according to claim 76, wherein the participants in the game are selected by the users of the web site.

78. The system according to claim 83, wherein the participants in the game are selected from the web site users logged-on while the television broadcast is transmitted.

79. The system according to claim 62, wherein the television broadcast is transmitted to the web site users via the communications network in real-time.

80. The system according to claim 79, wherein the television broadcast is transmitted to the web site users while the game is being played.

81. The system according to claim 79, wherein the game is further broadcast by conventional telecasting techniques.

82. The system according to claim 62, wherein the web site and the television broadcast cooperate to promote the products and services.

83. A multimedia system venue which elicits live response data from consumers, the system comprising:
a live television program;
an electronic commerce catalog;
an interactive Internet site; and
an electronic communications network linking the television program, the electronic commerce catalog and the interactive Internet site,
wherein users of the Internet site selectively affect content within the live television program, and the live television program is produced to function in tandem with the Internet site such that the content of the program determines the content of the electronic commerce catalog.

84. The system according to claim 83, wherein the Internet site is programmed to mutually exchange selected text, video and audio data between the users of the Internet site.

85. The system according to claim 83, wherein the content of the Internet site and the television program features products and services.

86. The system according to claim 85, wherein the products and services to be featured are selected based on data from users of the Internet site.

87. The system according to claim 83, wherein the electronic commerce catalog is archived after completion of an episode of the television program.

88. The system according to claim 87, wherein the archived catalog includes an accessible index for searching the catalog by content categories which pertain to aspects of episodes of the television program.

89. The system according to claim 83, wherein users of the Internet site are participants in the television program.

90. The system according to claim 89, wherein the electronic commerce catalog is indexed according to traits of the users of the Internet site.

91. The system according to claim 89, wherein the electronic commerce catalog is indexed according to preferences of the users of the Internet site.

92. The system according to claim 89, wherein the electronic commerce catalog is indexed according to traits and preferences of the users of the Internet site.

93. The system according to claim 92, wherein the electronic commerce catalog is searchable by one of trait, preference or trait and preference of the users of the Internet site.

94. The system according to claim 83, wherein the television program is transmitted to viewers via real-time video data transmission across the communications network.

95. The system according to claim 89, wherein the participants in the television program accrue credits by transmitting data across the communications network.

96. The system according to claim 95, wherein the credits have a redeemable value within the Internet site.

97. The system according to claim 95, wherein the credits have a redeemable value within the electronic commerce catalog.

98. The system according to claim 83, wherein the Internet site includes messaging and chat software which enables the interaction between the users of the Internet site.

99. The system according to claim 89, wherein the Internet site includes messaging and chat software which enables the interaction between the participants of the television program.

100. The system according to claim 89, wherein at least one participant in the television program is featured by way of live two-way video interaction with the Internet site and the television program.

101. The system according to claim 85, wherein the products and services featured are offered for purchase to the Internet site users.

102. The system according to claim 89, wherein the participants in the television program advance within a hierarchy.

103. The system according to claim 102, wherein the hierarchy is a multi-level incentive model system.

104. The system according to claim 89, wherein participants in the television program receive bonuses in the form of selected free products and services.

105. The system according to claim 95, wherein the credits are further accrued based on data received from the users of the Internet site.

106. The system according to claim 105, wherein the credits are further accrued by assisting other participants in the television program.

107. The system according to claim 83, wherein the Internet site includes links to informational and instructional databases.

108. A system for eliciting consumer data, comprising:
an interactive pathway;
a web site configured to interact via the pathway;
a television broadcast configured to interact with the web site via the pathway;
one or more user terminals configured to transmit user data to the web site via the pathway;
one or more supplier terminals configured to transmit information representing products and services to the web site via the pathway; and
an electronic commerce catalog linked to the web site and configured to sort the information representing the products and services based on the received user data.

109. A system for exchanging data between vendors and consumers, the system comprising:
a communications network;
an electronic commerce Internet catalog coupled to the communications network;
an interactive electronic commerce Internet site coupled to the communication network;
one or more user terminals coupled to the communications network and adapted to transmit user data to the Internet site;
one or more supplier terminals coupled to the communications network and adapted to transmit information representing products and services to the Internet site; and
a live program processor coupled to the communication network,
wherein the Internet site determines the products and services contained in the Internet catalog based on the user data,
wherein the live program processor is configured to produce a live television program based on the user data and the products and services in the Internet catalog.

110. The method according to claim 14, wherein the captured marketing data includes participant trait-related data and participant preference-related data, the method further comprising:
cataloging the products and services according to the participant trait-related data and the participant preference-related data.

111. The method according to claim 110, wherein the cataloged products and services are capable of being browsed the web site users by one of the participant trait-related data, the participant preference-related data or both the participant trait-related data and participant preference-related data.

112. The method according to claim 32, wherein the users of the Internet site are participants in the television program, and the electronic commerce catalog is indexed and searchable by one of traits, preferences or traits and preferences of the participants in the television program.

113. The system according to claim 65, wherein the users of the web site are television broadcast participants on the game, the marketing data includes participant trait-related data and participant preference related data, and the electronic commerce catalog is indexed and searchable by one of the participant trait-related, the participant preference-related or both participant trait-related and participant preference-related data.

114. The system according to claim 89, wherein the electronic commerce catalog is indexed and searchable according to one of traits, preferences or traits and preferences of the participants in the television program.
